(19) United States
(12) Patent Application Publication
(10) Pub. No.: US 2013/0186919 A1
(43) Pub. Date: Jul. 25, 2013

(54) Finish Dispensing Apparatus and Method of Use

(71) Applicants: James T. Jacques, Ogden, UT (US); James J. Jacques, Ogden, UT (US)

(72) Inventors: James T. Jacques, Ogden, UT (US); James J. Jacques, Ogden, UT (US)

(21) Appl. No.: 12/814,442

(22) Filed: Jun. 12, 2010

(51) Int. Cl. B67D 7/00

(52) U.S. Cl. 222/608

(57) ABSTRACT

The invention disclosed herein is a low cost, light weight, easy to use floor finish dispensing apparatus. The apparatus is a floor finish application apparatus defining a wheeled chassis mounted storage tank having a dispensing tube, wherein the chassis include a handle bar, the angular adjustment of which controls the flow rate of finish that is dispended from the storage tank. The apparatus is especially useful in efficiently and easily dispensing large quantities of floor finish such as Castlegaurd and Shurgloss 25 floor finishes at desired locations and in desired patterns such as elongated “puddle” finish patterns without overspray, finish splatter, finish waste, or user fatigue, and without the use of valves and levers.

### BACKGROUND

The present invention relates generally to machines that apply liquid chemicals. More particularly, the present invention relates to labor saving machines that apply liquid floor finish products to floors.

### RELATED ART

A variety of liquid dispensing machine and devices have long existed. Many such machines and devices are used in the floor cleaning, treating, and finishing industries. Many of the machines and devices include electrical motors or combustion engines, pressurized spray systems, spraying booms, and other complex features. Examples of such concepts are disclosed in the following US patents and applications which are incorporated herein by reference in their entirety: 7,223,038, 7,185,397, 7,048,458, 6,976,802, 6,467,983, 6,325,563, 6,227,744, 6,015,097, 4,260,273, 4,124,315, 4,119,386, 3,981,596, RE29,639, 20100047459, 2009002254, 20080279612 20080279610 20070294854, 20060280546, 20060236494, 20060228160, and Ser. No. 12/436,767. Furthermore, several floor finish compositions have been developed for use in creating a high luster and damage/scuff tolerant finish. While such finishes have increased in quality and utility over the years, such finishes are not inexpensive and the spillage of such finishes on surfaces or than the intended application surface can be problematic. Exemplary finishes include the following published specifications of finishes which are incorporated herein by reference in their entirety: Buckeye International Castleguard™ finish, Detco Industries ShurGloss 25™ finish, and Bona US Sport Seal™.

### SUMMARY

It has been recognized in the floor finishing industry that the application of floor finish in sufficient quantities and in an efficient time period while minimizing spillage and excess application of finish to a floor that is to be treated is a difficult and physically demanding task. Many of the above listed machines are heavy, include control cables, levers, and valves, and require motors or engines which increase the cost and reduce the reliability of the machine. Further, many such systems pressurize the finish resulting in over-spray of an expensive finish product. Further, such pressurized systems typically have correspondingly small finish application orifices which also result in increased machine clean-up difficulty. Given the lack of a machine that satisfies the needs of floor finish application, especially in the large or commercial floor finishing industry, many in the floor finishing industry have resorted to pouring floor finish by hand out of 1 gallon or other size containers, directly onto the floor to be finished. Such application of floor finish is not only imprecise and inefficient, it can be very taxing and painful to the back of the person performing such manual floor finish application. The invention therefore is a floor finish dispensing apparatus. The apparatus defines low cost light weight wheeled chassis mounted storage tank having a dispensing tube, wherein the chassis include a handle bar, the angular adjustment of which controls the flow rate of finish that is dispended from the storage tank. The apparatus is especially useful in efficiently and easily dispensing large quantities of floor finish such as Castlegaurd and Shurgloss 25 floor finishes at desired locations and in desired patterns such as elongated “puddle” finish patterns without overspray, finish splatter, finish waste, or user fatigue.

### BRIEF DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a substantially trimetric view of a first embodiment of the present invention;

FIG. 2 is a partially exploded substantially trimetric view of a first embodiment of the present invention;

FIG. 3 is a substantially orthographic side view of a first embodiment of the present invention in a first non-dispensing orientation; and

FIG. 4 is a substantially orthographic side view of a first embodiment of the present invention in a second dispensing orientation.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The invention is a floor finish application apparatus defining a wheeled chassis mounted storage tank having a dispensing tube, wherein the chassis include a handle bar, the angular adjustment of which controls the flow rate of finish that is dispended from the storage tank. The apparatus is especially useful in dispensing floor finish and other liquids preferably in elongated puddles or a “trails” without over-spray or splatter of the finish and without undue strain on the back of the person dispensing the finish.

In order to facilitate the understanding of the present invention in reviewing the drawings accompanying the specification, a feature list is provided below. It is noted that like features are like numbered throughout all of the figures.

FEATURE TABLE

| # | Feature | # | Feature |
|---|---|---|---|
| 10 | Finish dispensing apparatus | 20 | Chassis assembly |
| 30 | Platform assembly | 40 | Frame |
| 50 | Ring | 60 | Support bracket |
| 62 | Bracket lip | 64 | Bracket foot |
| 70 | Mount bracket assembly | 72 | Bracket shaft |
| 74 | Bracket thumbscrew | 80 | Wheel |
| 90 | Clamp bracket assembly | 92 | Bracket shaft |
| 94 | Bracket clamp | 96 | Bracket thumbscrew |
| 100 | Post | 102 | Post handle |
| 110 | Tube assembly | 112 | Tube |
| 114 | Tube elbow | 120 | Container assembly |
| 122 | Container | 124 | Container lid |
| 126 | Lid spout | 130 | Floor surface |
| 140 | Floor finish | | |

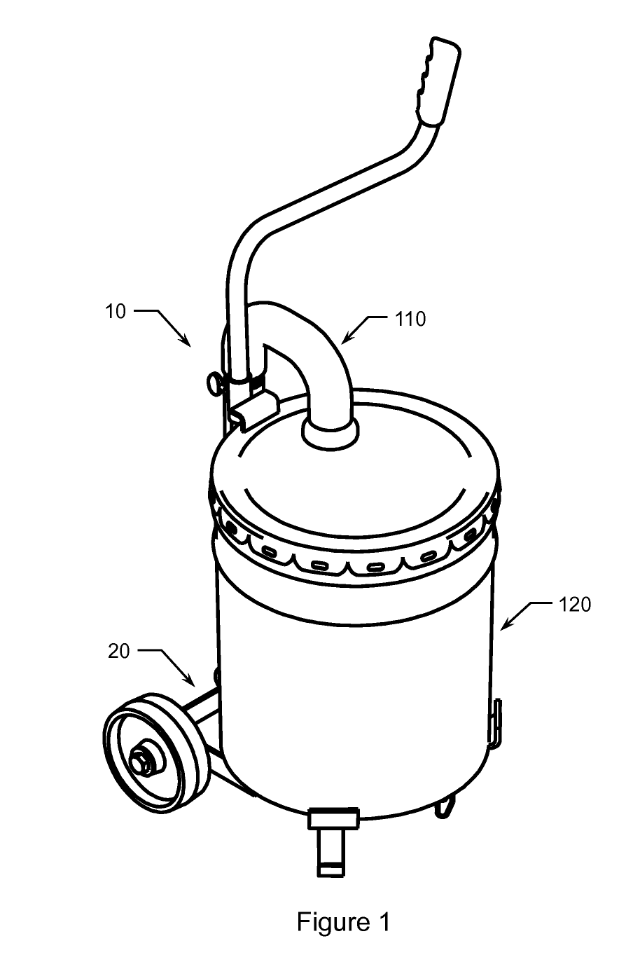

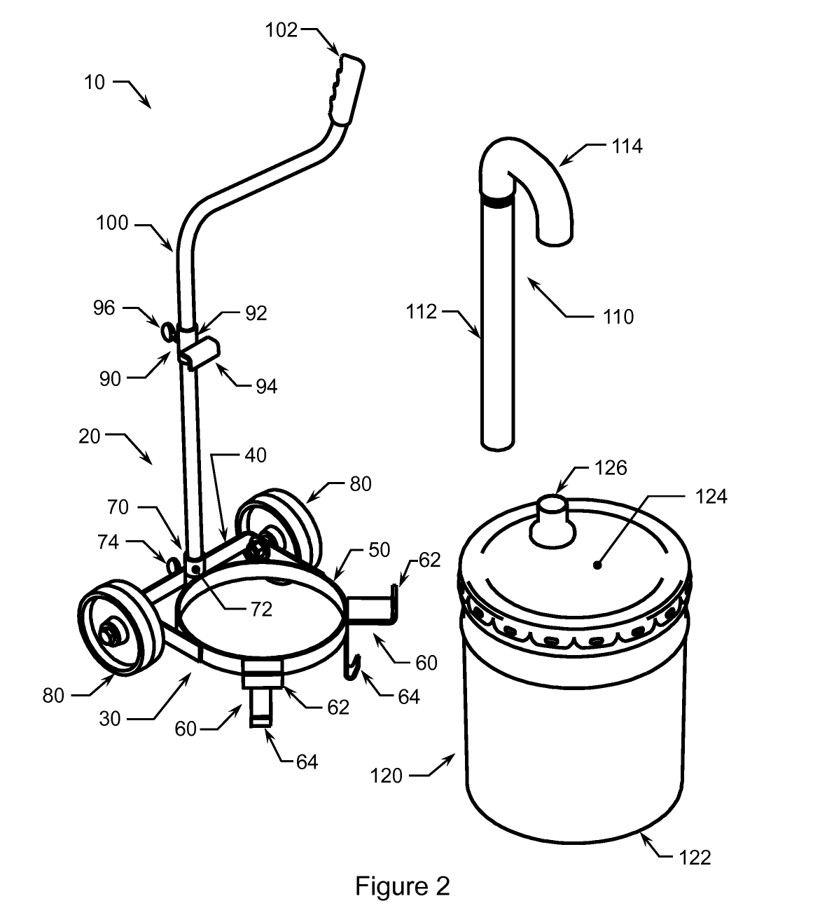

Referring now to the drawings and in particular to FIGS. 1 and 2, a first embodiment of the invention is a finish dispensing apparatus 10 for use in dispensing finish 140 comprising a chassis assembly 20, a tube assembly 110, and a container assembly 120. Chassis assembly 20 further defines a chassis assembly having a platform assembly 30, a post 100, and a clamp bracket assembly 90.

Platform assembly 30 further defines a platform assembly having a frame 40, a ring 50, a plurality of support brackets 60, a mount bracket assembly 70, and a plurality of wheels 80 (but preferably two of wheels 80). Frame 40 preferably defines a substantially “U” shaped formed metal frame. Ring 50 preferably defines a substantially circular shaped formed metal ring. Support bracket 60 preferably defines a formed metal bracket having foot portion and a lip portion. Mount bracket assembly 70 preferably defines a hollow metal shaft 72 having a thumbscrew 74 threadingly and adjustable connected to shaft 72. Wheel 80 preferably defines a convention commercially available wheel capable of carrying a load while rotating so as to provide for mobility of apparatus 10. Platform assembly 30 is preferably assembled such that frame 40 is welded to ring 50 with bracket 70 welded therebetween. Support brackets 60 are preferably welded to ring 50, and wheels 80 are rotatable connect to frame 40.

Post 100 further defines an elongated tubular formed metal post having an upper end and a lower end, with the upper end of post 100 terminating in a handle 102.

Clamp bracket assembly 90 preferably defines a hollow metal shaft 92 having a thumbscrew 96 threadingly and adjustable connected to shaft 92, and a metal “L” or angularly shaped clamp 94 preferably welded to shaft 92.

Chassis assembly 20 is preferably assembled such that clamp bracket assembly 90 slid onto Post 100 and temporarily fixed at a location on post 100 by the tightening of thumbscrew 96. The lower end of post 100 is position in shaft 72 and adjustably and removably fixed in place by tightening of thumbscrew 74.

Tube assembly 110 further defines a tube assembly having a tube 112 and an elbow 114. Tube 112 preferably defines a substantially clear flexible plastic tube. Elbow 114 preferably defines a clear plastic substantially 180 degree elbow. It is noted that in a preferred embodiment, the inner diameter of tube 112 and the inner diameter of elbow 114 are each at least 1.50 inches in diameter. It is noted that elbow 114 may optionally be assembled from two commercially available 90 degree PVC elbows and a short straight section of PVC pipe. Tube assembly 110 is preferably assembled such that a first end of tube 112 is press-fit into a first end of elbow 114.

Container assembly 120 further defines a container assembly having a container 122 and a container lid 124. Lid 124 further preferably includes a flexible plastic spout 126. Container 122 preferably contains a quality of liquid floor finish 140. It is noted that container 122 and lid 124 preferably define a standard commercially available 5 gallon metal bucket assembly which further may have a metal wire handle. In a preferred embodiment, the bucket assembly is obtained from a floor finish provider and comes complete with floor finish container therein and ready for mounting in chassis assembly 20.

Finish dispensing apparatus 10 is assembled such that container assembly 120 is removably placed on platform assembly 30 and clamp bracket assembly 90 is slidingly positioned into a clamping position in proximity to lid 124. Thumbscrew 96 is adjusted such that container assembly 120 is secured to chassis assembly 20. Tube assembly 110 is connected to container assembly 120 by press-fitting a second end of elbow 114 onto spout 126. It is noted that when finish dispensing apparatus 10 is thus assembled, the lower end of tube 112 is in near proximity to floor surface 130, and preferably is no further than 1.0 inches from floor surface 130 so as to avoid splatter of finish 140 when dispensing finish 140.

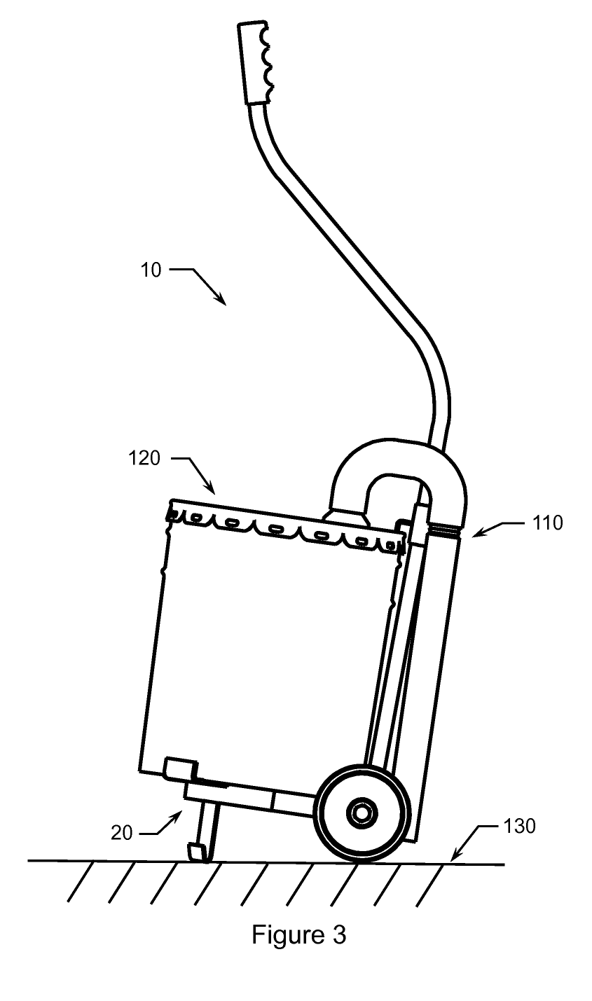

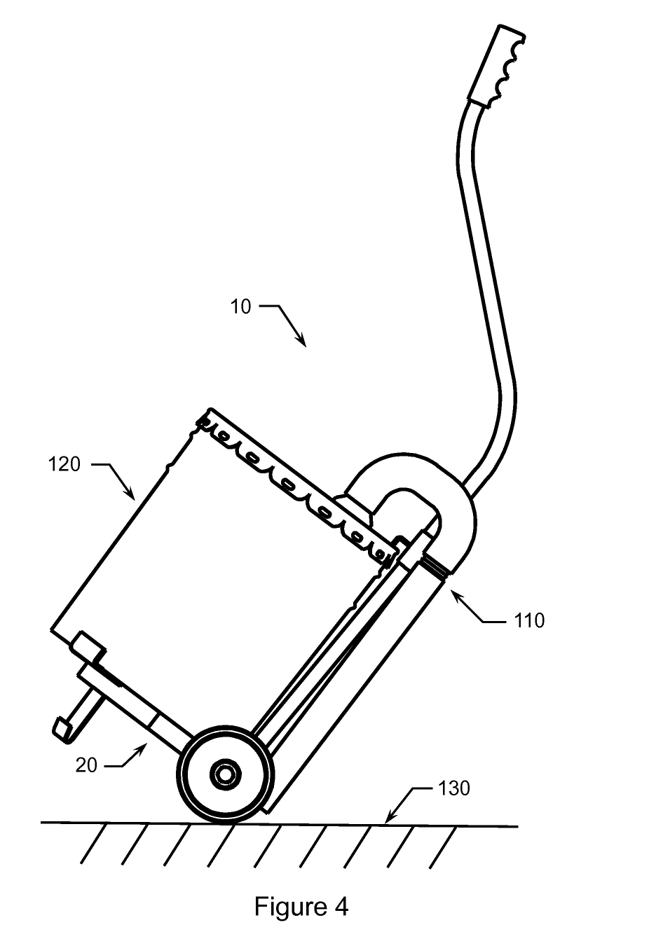

Referring now to the drawings and in particular to FIGS. 13 and 4, in practice with finish dispensing apparatus 10 thus assembled and resting upright on floor surface 130 as shown in FIG. 3, handle 102 is grasped and finish dispensing apparatus 10 is tilted such that floor finish 140 flows from tube 112 as shown in FIG. 4 while finish dispensing apparatus 10 is simultaneously moved across floor surface 130 in a backwards direction (i.e. in a direction such that the floor finish 140 is not walked on by the operator of finish dispensing apparatus 10). By using finish dispensing apparatus 10 in the manner described, significant quantities floor finish 140 is easily dispensed on floor surface 130 without operator fatigue and without the spills and splatter that would otherwise occur in hand application of floor finish 140. It is noted that in the use of finish dispensing apparatus 10, other that the tilting of finish dispensing apparatus 10 and the rotation of wheels 80, there are no moving parts or valves to be actuated. Finish dispensing apparatus 10 is a simple, light weight, collapsible machine that is of low manufacturing cost.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A liquid floor finish dispensing apparatus for use in easily dispensing floor finish directly onto a floor in large quantities and in “puddled” patterns without spraying, pressurizing, or splattering said finish and without expressing or forcing said finish through filtering or distributing media, said apparatus comprising a wheeled chassis and a storage container of containing liquid floor finish mounted to said chassis and having a spout connected to a tube, said tube having a liquid dispensing exit port, wherein when said apparatus is positioned in a first upright position, said liquid dispensing exit port is positioned below said spout and said apparatus prevents said liquid floor finish from exiting said exit port, and wherein when said apparatus is positioned in a second tilted position, said apparatus dispenses said liquid floor finish from said exit port, and wherein said apparatus is valve-free.

2. The apparatus of claim 1, wherein said storage container defines a removable substantially cylindrical shaped bucket having a liquid storage capacity of substantially 5 gallons.

3. The apparatus of claim 1, wherein when said apparatus is positioned in said first upright position said liquid dispensing exit port is positioned below said container.

4. The apparatus of claim 1, wherein said apparatus is adapted such that when said apparatus is resting on a floor surface, the minimum distance from said tube exit port to said floor surface is less than at least one of 6.0 inches, 5.0 inches, 4.0 inches, 3.0 inches, 2.0 inches, and 1.0 inch.

5. The apparatus of claim 1, wherein said tube includes an inner diameter, and wherein the size of said inner diameter defines an inner diameter size of at least one of 0.5 inches, 0.75 inches, 1.0 inch, 1.5 inches, 2.0 inches, and 3.0 inches.

6. The apparatus of claim 1, wherein said apparatus has less than four wheels.

7. The apparatus of claim 1, wherein said apparatus dispenses said liquid floor finish without pressurization by means of gravity feed at a rate of at least one of 0.25 gpm, 0.50 gpm, 0.75 gpm, 1.0 gpm, and 2.0 gpm.

8. The apparatus of claim 1, wherein said chassis includes a single handlebar.

9. A liquid floor finish dispensing apparatus for use in easily dispensing floor finish directly onto a floor in large quantities and in “puddled” patterns without spraying, pressurizing, or splattering said finish and without expressing or forcing said finish through filtering or distributing media, said apparatus comprising a wheeled chassis and a storage container containing liquid floor finish removably mounted to said chassis and having a spout connected to a tube, said tube having a liquid dispensing exit port positioned below said spout, and wherein said storage container defines a substantially cylindrical shaped bucket.

10. The apparatus of claim 9, wherein when said apparatus is positioned in a first upright position, said apparatus prevents said liquid floor finish from exiting said exit port, and wherein when said apparatus is positioned in a second tilted position, said apparatus dispenses said liquid floor finish from said exit port, and wherein said apparatus is valve-free.

11. The apparatus of claim 9, wherein said liquid dispensing exit port is positioned below said container.

12. The apparatus of claim 9, wherein said apparatus is adapted such that when said apparatus is resting on a floor surface, the minimum distance from said tube exit port to said floor surface is less than at least one of 6.0 inches, 5.0 inches, 4.0 inches, 3.0 inches, 2.0 inches, and 1.0 inch.

13. The apparatus of claim 9, wherein said tube includes an inner diameter, and wherein the size of said inner diameter defines an inner diameter size of at least one of 0.5 inches, 0.75 inches, 1.0 inch, 1.5 inches, 2.0 inches, and 3.0 inches.

14. The apparatus of claim 9, wherein said apparatus has less than four wheels.

15. The apparatus of claim 9, wherein said apparatus dispenses said liquid floor finish without pressurization by means of gravity feed at a rate of at least one of 0.25 gpm, 0.50 gpm, 0.75 gpm, 1.0 gpm, and 2.0 gpm.

16. The apparatus of claim 9, wherein said chassis includes a single handlebar.

17. A method of dispensing a liquid floor finish for use in easily dispensing floor finish directly onto a floor in large quantities and in “puddled” patterns without spraying, pressurizing, or splattering said finish and without expressing or forcing said finish through filtering or distributing media, said apparatus comprising the steps of providing a liquid floor finish dispensing apparatus comprising a wheeled chassis and a storage container of containing liquid floor finish mounted to said chassis and having a spout connected to a tube, said tube having a liquid dispensing exit port positioned below said spout when said apparatus is positioned in a first upright untilted position, tilting said apparatus such that said liquid floor finish flows from said exit port at a predetermined rate while rolling said apparatus on said chassis wheels across a floor surface.

18. The method of claim 17, wherein said storage container defines a removable substantially cylindrical shaped bucket, and wherein when said apparatus is positioned in a first upright position, said apparatus prevents said liquid floor finish from exiting said exit port, and wherein when said apparatus is positioned in a second tilted position, said apparatus dispenses said liquid floor finish from said exit port, and wherein said apparatus is valve-free.

19. The method of claim 17, wherein said liquid dispensing exit port is positioned below said container, and wherein chassis includes a single handlebar.

20. The method of claim 17, wherein said apparatus is adapted such that when said apparatus is resting on a floor surface, the minimum distance from said tube exit port to said floor surface is less than at least one of 6.0 inches, 5.0 inches, 4.0 inches, 3.0 inches, 2.0 inches, and 1.0 inch, and wherein said tube includes an inner diameter, and wherein the size of said inner diameter defines an inner diameter size of at least one of 0.5 inches, 0.75 inches, 1.0 inch, 1.5 inches, 2.0 inches, and 3.0 inch, and wherein said apparatus dispenses said liquid floor finish without pressurization by means of gravity feed at a rate of at least one of 0.25 gpm, 0.50 gpm, 0.75 gpm, 1.0 gpm, and 2.0 gpm, and wherein said apparatus has less than four wheels.
